(19) United States
(12) Patent Application Publication
(10) Pub. No.: US 2016/0109352 A1
(43) Pub. Date: Apr. 21, 2016

(54) METHODS AND APPARATUS FOR HIGH-THROUGHPUT LABEL-FREE CELL ASSAY

(71) Applicant: INDUSTRY-ACADEMIC COOPERATION FOUNDATION YONSEI UNIVERSITY, Seoul (KR)

(72) Inventors: Chulmin JOO, Goyang-si (KR); Su Ho RYU, Seoul (KR)

(21) Appl. No.: 14/680,231

(22) Filed: Apr. 7, 2015

(30) Foreign Application Priority Data
Apr. 17, 2014 (KR) 10-2014-0045706

(51) Int. Cl. G01N 15/14; G01N 21/25

(52) U.S. Cl. CPC G01N 15/1434; G01N 21/255; G01N 2015/1006

(57) ABSTRACT

The present invention relates to a high-throughput label-free cell assay system which scans a lower part of medium made of glass using an object lens and a Galvano mirror and using a broadband laser as a light source, analyzes and visualizes light reflected from the lower part of the medium using a spectrometer, measures interference spectra formed by the light reflected from each interface of the medium using the spectrometer, and measures phase from data that the measured interference spectra were converted by Fourier transform to observe structural change of cells. The system includes a transparent medium on which a sample is put, an object lens located beneath the transparent medium; a Galvano mirror located beneath the object lens; an optical fiber coupler transferring light from the super-continuum light source to the Galvano mirror; and the spectrometer detecting spectrum of the light from the optical fiber coupler.

### CROSS-REFERENCE TO RELATED APPLICATIONS

This application claims priority to Korean Application No. 10-2014-0045706, filed Apr. 17, 2014, the contents of which are incorporated herein in their entirety.

### BACKGROUND OF THE INVENTION

1. Field of the Invention

The present invention relates to a high-throughput label-free cell assay system which scans a lower part of a medium made of glass using an object lens and Galvano mirror and using a broadband laser as a light source, analyzes and visualizes light reflected from the lower part of the medium using a spectrometer, measures interference spectra formed by the light reflected from each interface of the medium using the spectrometer, and measures phase from a data that the measured interference spectra were converted by Fourier transform to observe a structural change of cells.

2. Background Art

In the cutting-edge medical biology fields, such as regenerative medicine, cell therapy, gene diagnosis, and so on, in order to carry out studies or diagnoses based on cells or genes, it is very important to obtain information by assaying cells.

The existing label-free cell assay technology does not use labels to cells but forms a nano-structure, such as an electrode, a diffraction grid or metal coating, on the medium to measure a structural change of cells and to observe optical or electrical changes generated when the structural change of the cells causes interaction between the cells and the nano-structure.

A label-free cell assay system has a complicated structure and is very expensive. Particularly, such a medium is very expensive because requiring a special nano-process and requires a lot of expenses because the medium is disposable due to a problem of pollution.

Therefore, people demand technology to closely observe a structural change of cells cultivated on a low-priced medium to which special treatment is not applied and which has a transparent plane.

As a prior art, Korean Patent No. 10-0888747 discloses a label-free bio-chip assay system and a bio-chip assay method using the same. The invention includes a resin layer of a special pattern (specific structure) formed on a substrate, but the resin layer requires a bio-chip which has a plurality of spots regularly arranged on the resin layer at regular intervals. Such a bio-chip is too expensive.

Particularly, the bio-chip causes interference by a pattern on the bio-chip. That is, light reflection occurs on the side wall which divides the spots, and hence, each side wall of the spot forms the Fabry-Perot interferometer structure. Therefore, if protein which is different in refractive index from air is connected, an optical path between the sides is changed so that the interference pattern is changed according to a concentration difference of protein. Therefore, the system can assay protein by sensing the change. Such an analysis using the pattern is very complicated, and the assay system for the analysis is too expensive.

Moreover, the materials to be assayed, such as cells, inside the bio-chip may be influenced by heat when light is irradiated from the top.

Therefore, people demand a high-throughput label-free cell assay system, which can closely observe a structural change of cells cultivated on a low-priced medium to which special treatment is not applied and which has a transparent plane, has a simple structure and is inexpensive.

### SUMMARY OF THE INVENTION

Accordingly, the present invention has been made to solve the above-mentioned problems occurring in the prior arts, and it is an object of the present invention to provide a high-throughput label-free cell assay system which scans a lower part of a medium made of glass using an object lens and a Galvano mirror and using a broadband laser as a light source, analyzes and visualizes light reflected from the lower part of the medium using a spectrometer, measures interference spectra formed by the light reflected from each interface of the medium using the spectrometer, and measures phase from a data that the measured interference spectra were converted by Fourier transform to observe a structural change of cells.

To accomplish the above object, according to the present invention, there is provided a high-throughput label-free cell assay system comprising: a transparent medium on which a sample is put and of which the bottom is transparent; an object lens which is located beneath the transparent medium; a Galvano mirror which is located beneath the object lens, has two mirrors, sends light incident from a super-continuum light source through an optical fiber coupler to the transparent medium through the object lens, and sends light returning from the transparent medium through the object lens to an optical fiber coupler while the two mirrors rotate; an optical fiber coupler which transfers light incident from the super-continuum light source to the Galvano mirror and transfers light incident from the Galvano mirror to a spectrometer; and the spectrometer which detects a spectrum of the light incident from the optical fiber coupler to output an image and to output an image of an interference spectrum formed by causing interference by the sample and the transparent medium.

Moreover, the high-throughput label-free cell assay system comprises: a super-continuum light source; an optical fiber coupler which transfers light incident from the super-continuum light source to a Galvano mirror and transfers light incident from the Galvano mirror to a spectrometer; the Galvano mirror which has two mirrors, transfers light incident from the super-continuum light source through the optical fiber coupler to an object lens, a transparent medium and a sample, and sends light returning through the transparent medium and the object lens from the sample to an optical fiber coupler; and a spectrometer which detects a spectrum of the light incident from the optical fiber coupler to output an image and to output an image of an interference spectrum formed by causing interference by the sample and the transparent medium.

The high-throughput label-free cell assay system further comprises an operation processing part which receives the image of the interference spectrum from the spectrometer and measures phase through Fourier transform.

The high-throughput label-free cell assay system further comprises a magnifier part which is located between the Galmano mirror and the object lens and has a convex lens.

The high-throughput label-free cell assay system further comprises a filter which is located between the super-continuum light source and the optical fiber coupler to output light of a predetermined wavelength band by filtering the light from the super-continuum light source.

The high-throughput label-free cell assay system further comprises a first collimator located between the filter and the optical fiber coupler to transfer the light incident from the filter to the optical fiber coupler through an optical fiber connected to the optical fiber coupler.

The high-throughput label-free cell assay system further comprises a second collimator located between the optical fiber coupler and the Galmano mirror to transfer the light exiting through the optical fiber connected to the optical fiber coupler to the Galmano mirror.

The magnifier part forms a confocal photosystem using a first convex lens and a second convex lens, and the caliber of the first convex lens is smaller than the caliber of the second convex lens.

The optical fiber coupler may be substituted with one of a beam splitter and a circulator.

The super-continuum light source is a laser which releases broadband wavelengths of 0.4 to 2.2 μm, and the transparent medium is formed in a flat plane plate shape. Here, the transparent medium may be a glass bottom dish.

The image of the interference spectrum is obtained when the light incident onto the transparent medium through the object lens is reflected from the sample and interference occurs by a boundary between the sample and the transparent medium.

In another aspect of the present invention, there is a high-throughput label-free cell assay method comprising: a first step of transferring light exiting from a super-continuum light source to an optical fiber coupler through a filter and a first collimator; a second step of transferring the light transferred in the first step to a Galvano mirror through a second collimator by the optical fiber coupler; a third step of transferring the light transferred in the second step to a magnifier part while mirrors of a Galvano mirror rotate and transferring the incident light to the sample put on the transparent medium through the object lens and the transparent medium by the magnifier part; a fourth step of reflecting the incident light from the sample and transferring the reflected light to the Galvano mirror through the magnifier part after passing through the transparent medium and the object lens; a fifth step of transferring the transferred light to the optical fiber coupler through a second collimator while the mirrors of the Galvano mirror rotate; a sixth step of transferring the transferred light to a spectrometer by the optical fiber coupler; and a seventh step of detecting a spectrum of the incident light and outputting an image by the spectrometer and outputting an image of an interference spectrum formed by causing interference by the sample and the transparent medium.

The high-throughput label-free cell assay method further comprises an eighth step of carrying out Fourier transform when an operation processing part receives the image of the interference spectrum to measure phase.

The super-continuum light source is one of a tungsten lamp, a tungsten halogen lamp, a xenon lamp, a super-luminescent diode, a Ti-sapphire laser and a wavelength swept laser.

In a further aspect of the present invention, there is a high-throughput label-free cell assay system comprising: a transparent medium on which a sample is put and of which the bottom is transparent; an object lens which is located beneath the transparent medium; a Galvano mirror which is located beneath the object lens, has two mirrors, sends light incident from a wavelength swept light source through an optical fiber circulator to the transparent medium through the object lens, and sends light returning from the transparent medium through the object lens to the optical fiber circulator while the two mirrors rotate; the optical fiber circulator which transfers light incident from the wavelength swept light source to the Galvano mirror and transfers light incident from the Galvano mirror to an optical diode; and the optical diode which detects a spectrum of the light incident from the optical fiber circulator to output an interference spectrum formed by causing interference by the sample and the transparent medium.

The high-throughput label-free cell assay system further comprises: an operation processing part which receives the image of the interference spectrum from the optical diode and measures phase through Fourier transform; and a filter which is located between the super-continuum light source and the optical fiber coupler to output light of a predetermined wavelength band by filtering the light from the wavelength swept light source.

In a still further aspect of the present invention, there is a high-throughput label-free cell assay system comprising: a transparent medium on which a sample is put and of which the bottom is transparent; an object lens which is located beneath the transparent medium; a beam splitter which is located beneath the object lens, has two mirrors, sends light incident from wavelength swept light source to the transparent medium through the object lens, and sends light returning from the transparent medium through the object lens to a CCD camera; and a CCD camera which detects the light incident from the beam splitter to output an image of an optical interference phase formed by causing interference by the sample and the transparent medium.

The high-throughput label-free cell assay system further comprises a filter which is located between the wavelength swept light source and the beam splitter to output light of a predetermined wavelength band by filtering the light from the wavelength swept light source.

According to the present invention, the high-throughput label-free cell assay system can scan the lower part of the medium made of glass using the object lens and the Galvano mirror and using the broadband laser as a light source, analyze and visualizes light reflected from the lower part of the medium using the spectrometer, measure interference spectra formed by the light reflected from each interface of the medium using the spectrometer, and measure phase from a data that the measured interference spectra were converted by Fourier transform to observe the structural change of cells.

The high-throughput label-free cell assay system according to the present invention can closely observe a structural change of cells cultivated on a low-priced medium to which special treatment is not applied and which has a transparent plane, has a simple structure and is inexpensive.

The high-throughput label-free cell assay system according to the present invention is applicable to real time cell monitoring, real time protein bonding reaction monitoring, photothermal sensors, three-dimensional videomicrography and chemical sensors.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic diagram showing the configuration of a high-throughput label-free cell assay system according to an embodiment of the present invention;

FIG. 2 is a view showing light on a transparent medium of the high-throughput label-free cell assay system according to the present invention;

FIG. 3 is a view showing analysis by a spectrometer of the high-throughput label-free cell assay system according to the present invention;

FIG. 4 is a view showing an example of an image of cells photographed by an optical interference phase microscope beneath the transparent medium of the high-throughput label-free cell assay system;

FIG. 5 is a view showing an example of a measurement value by time in the high-throughput label-free cell assay system in a case that picolinic acid and histamine are separately given to cells in different concentration;

FIG. 6 is a view showing an example of a glass bottom dish which generally comes into the market;

FIG. 7 is a schematic diagram showing a configuration of a high-throughput label-free cell assay system according to another embodiment of the present invention;

FIG. 8 is a schematic diagram showing a configuration of a high-throughput label-free cell assay system according to a further embodiment of the present invention; and

FIG. 9 is a schematic diagram showing a configuration of a high-throughput label-free cell assay system according to a still further embodiment of the present invention.

### DETAILED DESCRIPTION OF THE PREFERRED EMBODIMENT

Reference will be now made in detail to embodiments of the present disclosure with reference to the attached drawings. It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the disclosure.

Hereinafter, with reference to the attached drawings, a system and a method for high-throughput label-free cell assay according to the present invention will be described in detail.

In the present invention, a transparent medium is not treated with anything except glycoprotein coating for general cell culture.

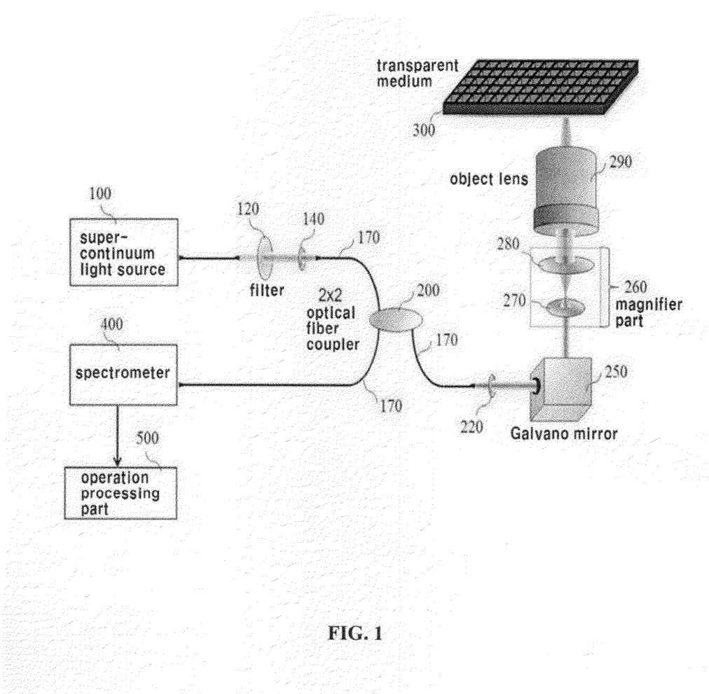

FIG. 1 is a schematic diagram showing the configuration of a high-throughput label-free cell assay system according to an embodiment of the present invention. The high-throughput label-free cell assay system includes a super-continuum light source 100, a filter 120, a spectrometer 400, an optical fiber coupler 200, a Galvano mirror 250, a magnifier part 260, an object lens 290 and a transparent medium 300.

The super-continuum light source 100 is a light source which is not a monochromatic light source but has a wide spectral radiance spectrum, and may be a super-continuum laser light source, such as a white light source, a super-luminescent diode, a Ti-sapphire laser and so on. Alternatively, the super-continuum light source 100 may be a wavelength swept laser. In this instance, instead of the spectrometer, a light diode may be used. As the white light source, there are tungsten lamps, tungsten halogen lamps, xenon lamps and so on.

The filter 120 is located below the super-continuum light source 100 and is an optical filter for selectively outputting light inputted from the super-continuum light source 100 into light of a specific wavelength band.

In the present invention, as the super-continuum light source 100, a laser which simultaneously releases broadband wavelengths of 0.4 to 2.2 μm. Because the spectrometer 400 cannot detect all of the corresponding wavelengths, the filter 120 is used to filter only a necessary area.

A first collimator 140 is located below the filter 120, collects rays incident from the super-continuum light source 100 through the filter 120 and converts the collected rays into parallel rays so that the parallel rays are incident on an optical fiber 170 and rays exiting from the first collimator 140 is incident on the optical fiber coupler 200.

One side of the optical fiber coupler 200 is connected with the optical fiber 170 connected with the first collimator 140 and the optical fiber 170 connected with the spectrometer 400, and the other side is connected with the optical fiber 170 connected with a second collimator 220. The optical fiber coupler 200 is means for sending the light incident from the super-continuum light source 100 through the filter 120 to the Galvano mirror 250 and sending the light incident from the transparent medium 300 through the Galvano mirror 250 to the spectrometer 400. That is, the optical fiber coupler 200 transfers the light incident through the super-continuum light source 100, the filter 120 and the first collimator 140 to the Galvano mirror 250 through the second collimator 220. Furthermore, the optical fiber coupler 200 sends the light which is reflected from the transparent medium 300 and is incident through the magnifier part 260, the Galvano mirror 250 and the second collimator 220 to the spectrometer 400.

Here, the optical fiber coupler 200 is used as an optical substitute based on optical fiber of a beam splitter. Differently from the existing OCT, the optical fiber coupler 200 does not use reference light and observes interference of light returning from measured light.

In the present invention, the optical fiber coupler 200 may be substituted with a beam splitter or a circulator, and even though the optical fiber coupler 200 is substituted with the beam splitter or the circulator, it provides the same result.

The second collimator 220 is located between the optical fiber 170 connected with the optical fiber coupler 200 and the Galvano mirror 250, collects rays incident from the Galvano mirror 250 and converts the collected rays into parallel rays so that the parallel rays are incident on the optical fiber 170 connected with the optical fiber coupler 200 and rays exiting from the second collimator 220 is incident on the optical fiber coupler 200 and is transferred to the spectrometer 400.

The Galvano mirror 250 is located between the second collimator 220 and the magnifier part 260, includes two rotating mirrors which are arranged vertically to carry out two-dimensional scanning. The Galvano mirror 250 sends the light incident from the optical fiber coupler 200 through the second collimator 220 to the bottom of a transparent medium 300 through the magnifier part 260 and the object lens 290 in order while rotating. Moreover, the Galvano mirror 250 sends the light reflected from the bottom of the transparent medium 300 through the object lens 290 and the magnifier part 260 in order while rotating so that the light is transferred to the optical fiber coupler 200 through the second collimator 220. The Galvano mirror 250 may be a scanner.

The magnifier part 260 is located between the Galvano mirror 250 and the object lens 290 and forms a confocal photosystem using a first convex lens 270 and a second convex lens 280, and expands light incident from the optical fiber coupler 200 through the second collimator 220. Here, the magnifier part 260 can expand the incident rays by two times. That is, the magnifier part 260 expands the rays before the rays form focus by the object lens to increase the number of apertures between the lens and the rays so as to increase resolution by forming a small focus. Here, the caliber of the first convex lens 270 is smaller than the caliber of the second convex lens 280.

As an occasion demands, the magnifier part 260 may be omitted.

The object lens 290 is located below the transparent medium 300 and is to make the light incident from the optical fiber coupler 200 form focus on the transparent medium 300. That is, the object lens 290 forms focus on the transparent medium 300 through the object lens 290 after expanding the parallel light exiting from the optical fiber coupler 200 through the magnifier part 260 in order to enhance resolution. The light including information of an object by being scattered by a sample of the transparent medium 300 is reflected as it is, and then, enters the optical fiber coupler 200 through the object lens 290, the magnifier part 260, the Galvano mirror 250 and the second collimator 220.

The transparent medium 300 is means for cultivating cells, and may be a general medium of a transparent plane plate type which has no specific treatment. The transparent medium 300 may be a transparent medium called a glass bottom dish which comes onto the market and adopts the form that glass is bonded beneath a sterilized frame made of plastic. In the present invention, as the transparent medium 300, if it has a transparent bottom, any medium can be used regardless of forms.

The spectrometer 400 includes a scan camera or a line scan camera, detects a spectrum of interference light incident from the optical fiber coupler 200, and obtains an image of each pixel through analysis of the spectrum. That is, the spectrometer 400 detects the spectrum from the light that is reflected from the transparent medium 300 and is incident through the magnifier part 260, the Galvano mirror 250, the second collimator 220 and the optical fiber coupler 200, and obtains an image of each pixel, namely, an image of the interference spectrum, through analysis of the spectrum. The spectrometer 400 may be a known spectrometer which comes on the market.

An operation processing part 500 is connected with the spectrometer 400 by wire or wirelessly, receives the image of the interference spectrum and applies Fourier transform to each pixel of the image of the received interference spectrum to measure phase. In other words, the operation processing part 500 can measure phase from a data which is converted through the Fourier transform of the interference spectrum so as to observe a structural change of cells. Here, the operation processing part 500 may include a microprocessor or a computer.

In general, time function u(t) may be converted into frequency function U(ω) through the Fourier transform, the frequency function U(ω) is indicated in a plural form, and is expressed by amplitude and phase.

In the present invention, a measured value of the spectrometer 400 is transferred to a computer based on communication protocol having CameraLink, GigaE, USB and so on, and the transferred signal is converted into a digital image through a series of signal process including the Fourier transform in a computer.

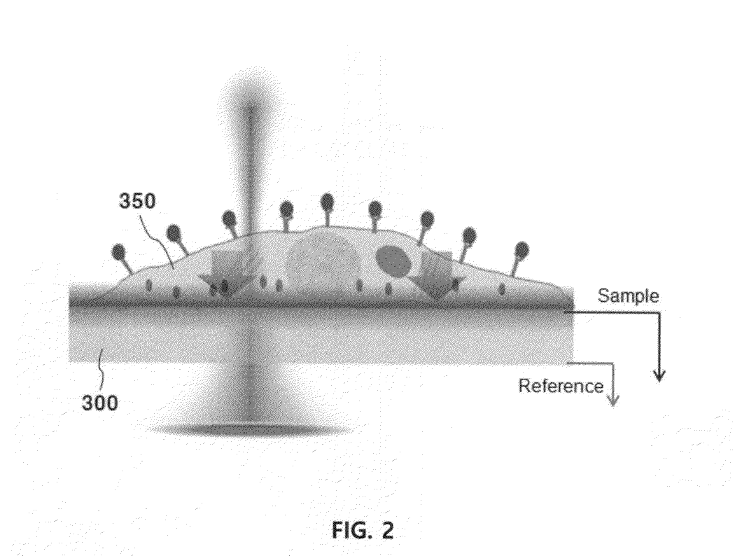

FIG. 2 is a view showing light on a transparent medium of the high-throughput label-free cell assay system according to the present invention.

The light incident on the transparent medium 300 through the object lens 290 is reflected at the sample 350 and causes interference by the sample 350 and the transparent medium 300. The light reflected and returned from each interface of the transparent medium 300 forms an interference spectrum. That is, based on light reflected without being incident on the sample 350, out of the light incident on the transparent medium 300 through the object lens 290, the light reflected from the sample 350 can be measured.

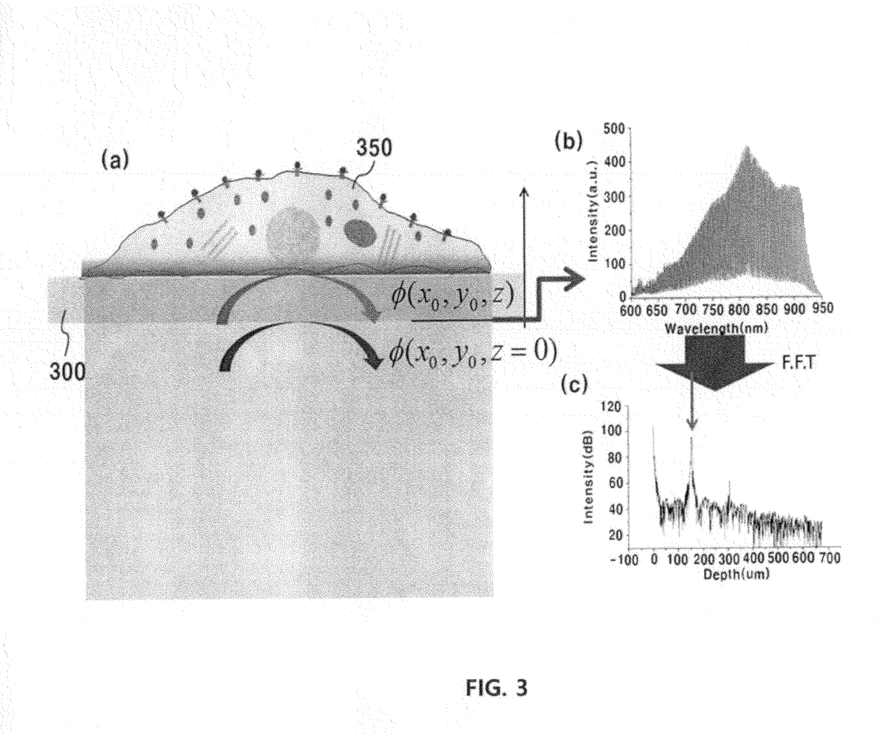

FIG. 3 is a view showing analysis by a spectrometer of the high-throughput label-free cell assay system according to the present invention. (a) of FIG. 3 is a view showing light on a transparent medium of the high-power label-free cell assay system according to the present invention.

The spectrometer 400 indicates the light reflecting and returning against the transparent medium 300, for instance, glass, by intensity (spectrum) according to the wavelength as shown in (b) of FIG. 3. If an FFT is applied to it, the light is indicated by intensity (spectrum) according to the depth as shown in (c) of FIG. 3, and hence, the spectrometer 400 can measure the interference spectrum formed by the transparent medium 300. Next, the operation processing part 500 measures phase from the data that the spectrum is converted by the Fourier transform in order observe the structural change of the cells.

In general, the FFT is applied to an interference signal, information of the depth can be obtained. After that, the Fourier transform is carried out again, features of phase can protrude more.

The spectrometer 400 outputs just information of intensity by wavelength. (b) of FIG. 3 shows an example of output of the spectrometer. After that, the operation processing part 500 carries out the Fourier transform and treatment.

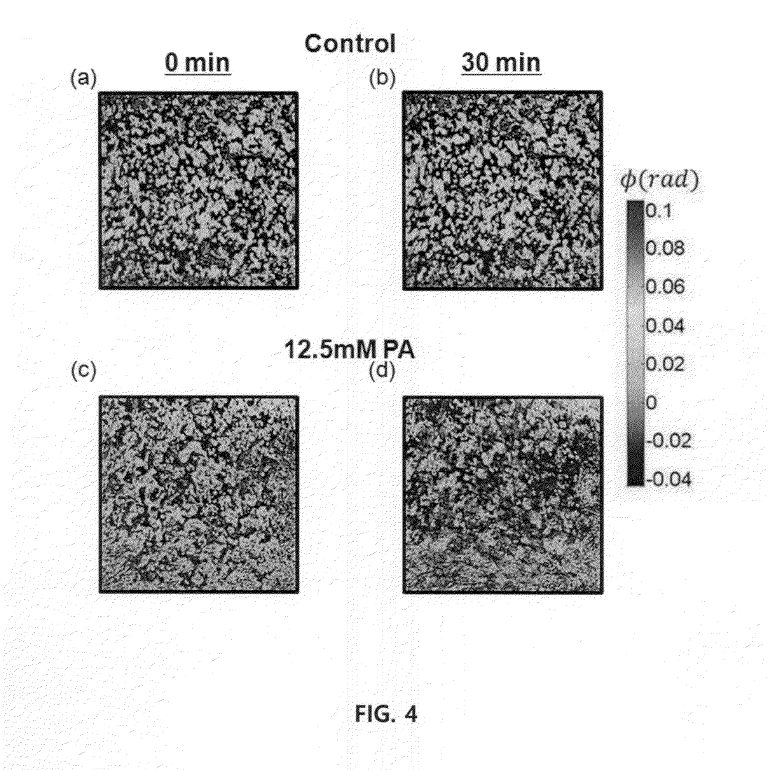

FIG. 4 is a view showing an example of an image of cells photographed by an optical interference phase microscope beneath the transparent medium of the high-throughput label-free cell assay system.

(a) of FIG. 4 shows an image captured by an optical interference phase microscope in a case that there is no specific treatment on the cells, and (b) of FIG. 4 shows an image captured after a lapse of 30 minutes in the state of the cells of (a) of FIG. 4.

(c) of FIG. 4 shows an image captured by the optical interference phase microscope directly after picolinic acid which kills cells is dosed, and (d) of FIG. 4 shows an image captured after a lapse of 30 minutes in the state of the cells of (c) of FIG. 4.

As shown in (b) of FIG. 4, there was no change even after a lapse of 30 minutes, but in half an hour after picolinic acid was dosed, the number of observed cells was remarkably reduced. That is, it is possible to observe cells using the interference phenomenon below the transparent medium.

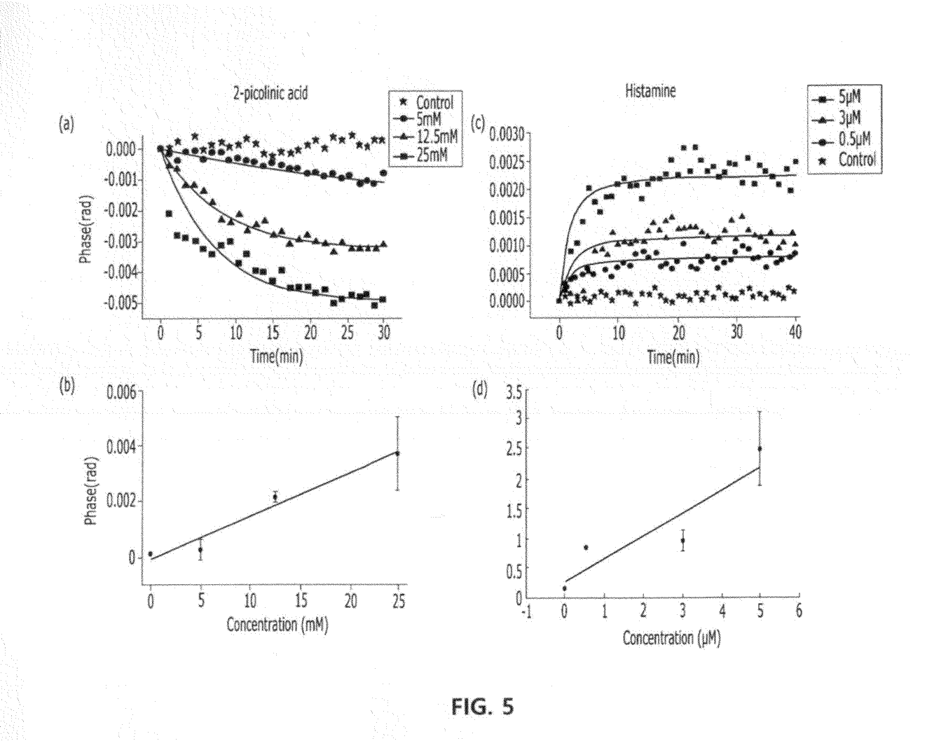

FIG. 5 is a view showing an example of a measurement value by time in the high-throughput label-free cell assay system in a case that picolinic acid and histamine are separately given to cells in different concentration.

(a) of FIG. 5 shows a case that picolinic acid is dosed in different concentration, and (b) of FIG. 5 shows a case that histamine is dosed in different concentration. (c) of FIG. 5 shows concentration and phase of (a) of FIG. 5, and (d) of FIG. 5 shows concentration and phase of (b) of FIG. 5.

In (a) of FIG. 5 and (b) of FIG. 5, picolinic acid and histamine showed different aspects as time went by, and in the two experiments, remarkable changes in measurement values depending on concentration were observed.

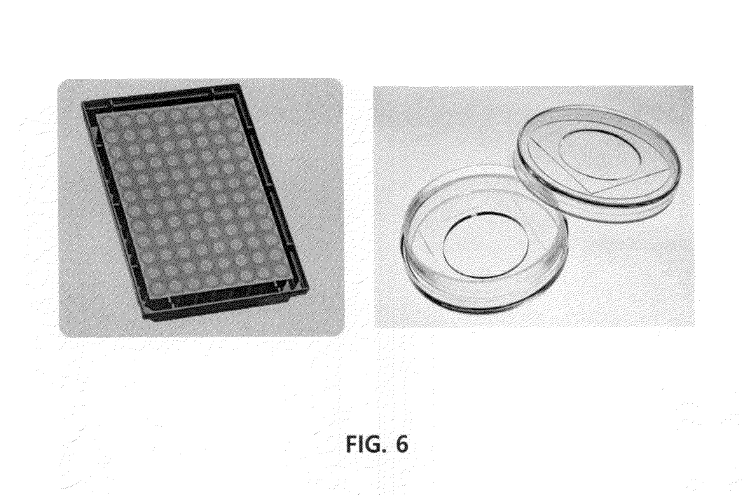

FIG. 6 is a view showing an example of a glass bottom dish which generally comes into the market.

The glass bottom dish adopts the form that glass is bonded beneath a sterilized frame made of plastic (Refer to http://www.liveassay.com/wp-content/uploads/2011/11/96-Well.jpg, and http://www.invitrosci.com/images/glass_top_glass_bottom_dish_35_20_huge.jpg)

The present invention is an interference imager based on a common-path Michelson interferometer which does not require a reference part and includes an optical fiber coupler or a beam splitter, and may use an optical fiber circulator instead of the beam splitting device, such as the optical fiber coupler and the beam splitter. The interference imager converts light of a light source into parallel light using one of the optical fiber coupler, the beam splitter or the circulator, sends the parallel beam to the Galvano mirror (scanner), and sends the light, which returns after being incident on the transparent medium from the Galvano mirror (scanner) through a lens of the magnifier part, to the spectrometer as it is.

The present invention uses a wavelength swept light source as the super-continuum light source 100, and the spectrometer 400 may be substituted with an optical diode.

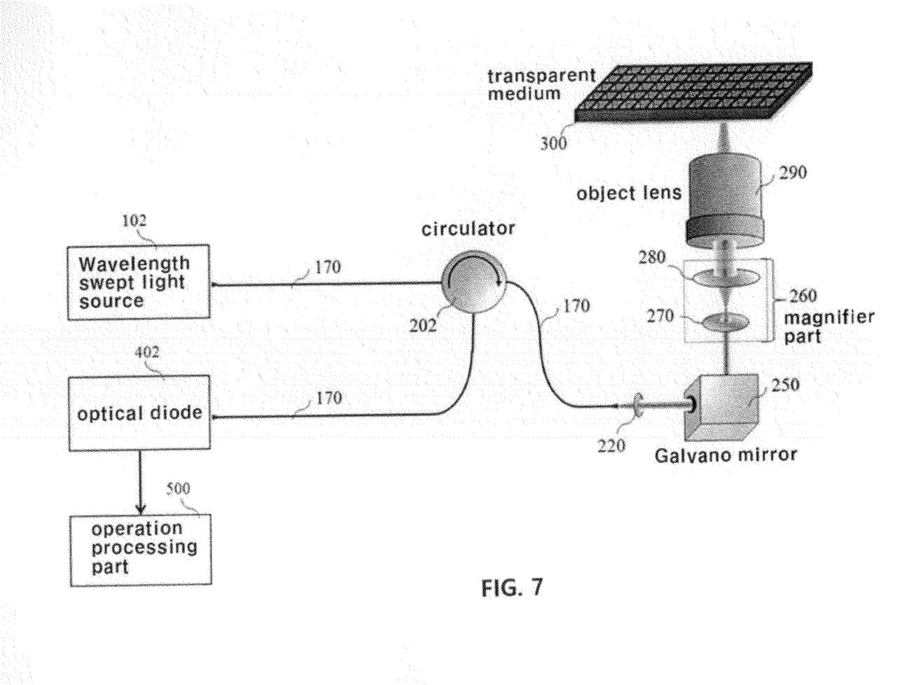

FIG. 7 is a schematic diagram showing a configuration of a high-throughput label-free cell assay system according to another embodiment of the present invention. The high-throughput label-free cell assay system includes a wavelength swept light source 102, an optical diode 402, an optical fiber circulator 202, a Galvano mirror 250, a magnifier part 260, an object lens 290 and a transparent medium 300.

The high-throughput label-free cell assay system shown in FIG. 7 uses the wavelength swept light source 102 instead of the super-continuum light source 100, the optical diode 402 instead of the spectrometer 400, and the optical fiber circulator 202 instead of the optical fiber coupler 200. Otherwise it, the high-throughput label-free cell assay system shown in FIG. 7 is the same as that shown in FIG. 1.

Light is transferred from the wavelength swept light source 102 to the optical fiber circulator 202 through the optical fiber 170, and the transferred light is sent to the Galvano mirror 250 from the optical fiber circulator 202 through the second collimator 220. The Galvano mirror 250 sends the incident light to the bottom of a transparent medium 300 through the magnifier part 260 and the object lens 290 in order while rotating, and then, sends the light reflected from the bottom of the transparent medium 300 through the object lens 290 and the magnifier part 260 in order while rotating so that the light is transferred to the optical fiber circulator 202 through the second collimator 220. The optical fiber circulator 202 sends the light incident through the second collimator 220 to the optical diode 402. The optical diode 402 detects a spectrum from the incident light and transfers to the operation processing part 500.

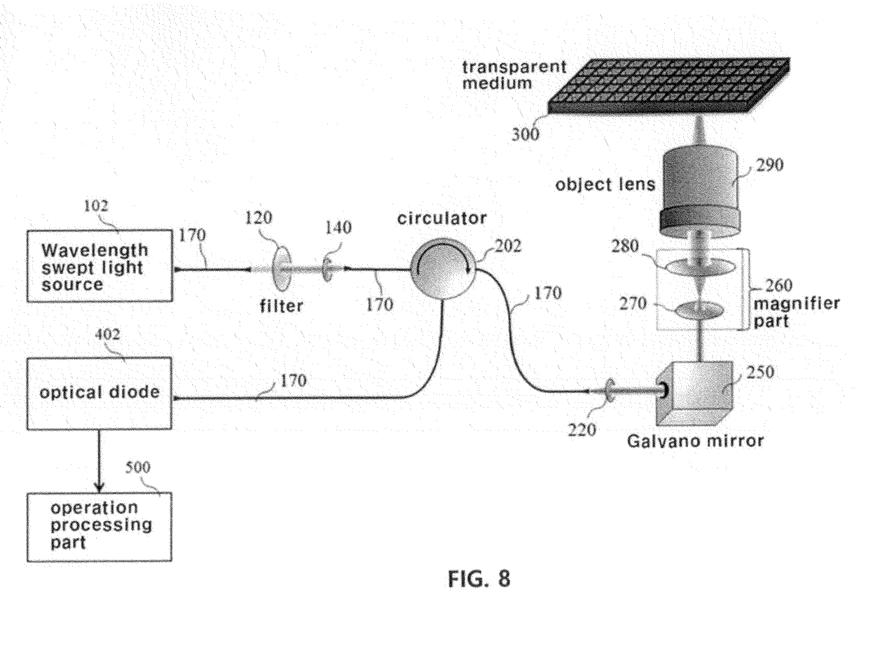

FIG. 8 is a schematic diagram showing a configuration of a high-throughput label-free cell assay system according to a further embodiment of the present invention. The high-throughput label-free cell assay system includes a wavelength swept light source 102, a filter 120, an optical diode 402, an optical fiber circulator 202, a Galvano mirror 250, a magnifier part 260, an object lens 290 and a transparent medium 300.

The high-throughput label-free cell assay system shown in FIG. 8 further includes the filter 120 in the high-throughput label-free cell assay system shown in FIG. 7. That is, the high-throughput label-free cell assay system selectively outputs light transferred from the wavelength swept light source 102 into light of a specific wavelength band in the filter 120, and then, transfers the light to the optical fiber circulator 202 through the first collimator 140. Otherwise it, the high-throughput label-free cell assay system shown in FIG. 8 is the same as that shown in FIG. 7.

Additionally, the present invention may use the wavelength swept light source as the super-continuum light source 100 and use a beam splitter instead of the optical fiber coupler 200. In this instance, the high-throughput label-free cell assay system may be used as a wide field optical interference phase microscope.

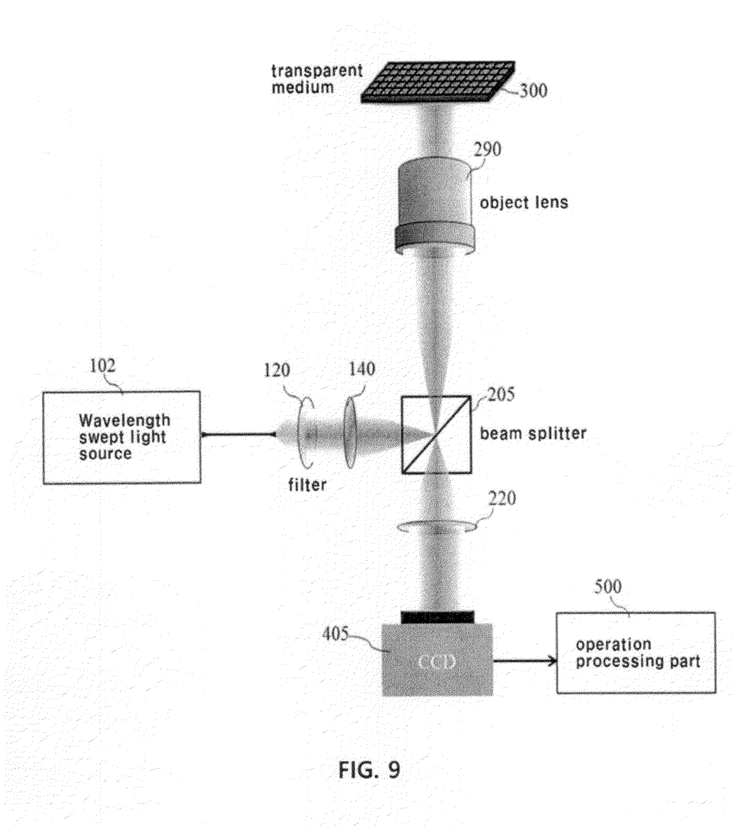

FIG. 9 is a schematic diagram showing a configuration of a high-throughput label-free cell assay system according to a still further embodiment of the present invention. The high-throughput label-free cell assay system includes a wavelength swept light source 102, a filter 120, a CCD camera 405, a beam splitter 205, an object lens 290 and a transparent medium 300.

The high-throughput label-free cell assay system selectively outputs light transferred from the wavelength swept light source 102 into light of a specific wavelength band in the filter 120, and then, transfers the light to the beam splitter 205 through the first collimator 140. The light incident on the beam splitter 205 through the first collimator 140 is sent to the bottom of the transparent medium 300 through the object lens 290, and the light reflected from the bottom of the transparent medium 300 is transferred to the beam splitter 205 through the object lens 290. The light incident on the beam splitter 205 through the object lens 290 is transferred to the operation processing part 500 after the COD camera 405 detects an image through the second collimator 220.

The high-throughput label-free cell assay system shown in FIG. 9 widely radiates the wavelength swept light source 102 onto the transparent medium 300 at once and projects the light returning from each point to the CCD camera 405 as it is so as to obtain a two-dimensional image without scanning. In this instance, only the beam splitter 205 can be used, and each pixel of the CCD camera 405 operates like a spectrometer or an optical diode of other system. Each pixel outputs phase information of each pixel through the Fourier transform in the operation processing part 500.

As described above, while the present invention has been particularly shown and described with reference to the limited embodiments and drawings thereof, it will be understood by those of ordinary skill in the art that the present invention is not limited to the specific embodiments of the present invention and various changes and modifications may be derived from the embodiments of the present invention. Therefore, it should be also understood that the protective scope and technical idea of the present invention must be interpreted by the following claims and all changes, modifications and equivalences of the present invention belong to the technical scope of the present invention.

Further, the embodiments discussed have been presented by way of example only and not limitation. Thus, the breadth and scope of the invention(s) should not be limited by any of the above-described exemplary embodiments, but should be defined only in accordance with the following claims and their equivalents. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A high-throughput label-free cell assay system comprising:
a transparent medium on which a sample is put and of which the bottom is transparent;
an object lens which is located beneath the transparent medium;
a Galvano mirror which is located beneath the object lens, has two mirrors, sends light incident from a super-continuum light source through an optical fiber coupler to the transparent medium through the object lens, and sends light returning from the transparent medium through the object lens to an optical fiber coupler while the two mirrors rotate;
an optical fiber coupler which transfers light incident from the super-continuum light source to the Galvano mirror and transfers light incident from the Galvano mirror to a spectrometer; and
the spectrometer which detects a spectrum of the light incident from the optical fiber coupler to output an image and to output an image of an interference spectrum formed by causing interference by the sample and the transparent medium.

2. The high-throughput label-free cell assay system according to claim 1, further comprising:
an operation processing part which receives the image of the interference spectrum from the spectrometer and measures phase through Fourier transform.

3. The high-throughput label-free cell assay system according to claim 2, further comprising:
a filter which is located between the super-continuum light source and the optical fiber coupler to output light of a predetermined wavelength band by filtering the light from the super-continuum light source.

4. The high-throughput label-free cell assay system according to claim 3, further comprising:
a first collimator located between the filter and the optical fiber coupler to transfer the light incident from the filter to the optical fiber coupler through an optical fiber connected to the optical fiber coupler.

5. The high-throughput label-free cell assay system according to claim 2, further comprising:
a second collimator located between the optical fiber coupler and the Galmano mirror to transfer the light exiting through the optical fiber connected to the optical fiber coupler to the Galmano mirror.

6. The high-throughput label-free cell assay system according to claim 1, further comprising:
a magnifier part which is located between the Galmano mirror and the object lens and has a convex lens.

7. The high-throughput label-free cell assay system according to claim 6, wherein the magnifier part forms a confocal photosystem using a first convex lens and a second convex lens, and the caliber of the first convex lens is smaller than the caliber of the second convex lens.

8. The high-throughput label-free cell assay system according to claim 1, wherein the super-continuum light source is a laser which releases broadband wavelengths of 0.4 to 2.2 μm.

9. The high-throughput label-free cell assay system according to claim 1, wherein the transparent medium is formed in a flat plane plate shape.

10. The high-throughput label-free cell assay system according to claim 1, wherein the image of the interference spectrum is obtained when the light incident onto the transparent medium through the object lens is reflected from the sample and interference occurs by a boundary between the sample and the transparent medium.

11. The high-throughput label-free cell assay system according to claim 1, wherein the super-continuum light source is one of a tungsten lamp, a tungsten halogen lamp, a xenon lamp, a super-luminescent diode, a Ti-sapphire laser and a wavelength swept laser.

12. A high-throughput label-free cell assay method comprising:
a first step of transferring light exiting from a super-continuum light source to an optical fiber coupler through a filter and a first collimator;
a second step of transferring the light transferred in the first step to a Galvano mirror through a second collimator by the optical fiber coupler;
a third step of transferring the light transferred in the second step to a magnifier part while mirrors of a Galvano mirror rotate and transferring the incident light to the sample put on the transparent medium through the object lens and the transparent medium by the magnifier part;
a fourth step of reflecting the incident light from the sample and transferring the reflected light to the Galvano mirror through the magnifier part after passing through the transparent medium and the object lens;
a fifth step of transferring the transferred light to the optical fiber coupler through a second collimator while the mirrors of the Galvano mirror rotate;
a sixth step of transferring the transferred light to a spectrometer by the optical fiber coupler; and
a seventh step of detecting a spectrum of the incident light and outputting an image by the spectrometer and outputting an image of an interference spectrum formed by causing interference by the sample and the transparent medium.

13. The high-throughput label-free cell assay method according to claim 12, further comprising:
an eighth step of carrying out Fourier transform when an operation processing part receives the image of the interference spectrum to measure phase.

14. The high-throughput label-free cell assay method according to claim 12, wherein the image of the interference spectrum is obtained when the light incident onto the transparent medium through the object lens is reflected from the sample and interference is caused by the boundary between the sample and the transparent medium.
